(19) United States
(12) Patent Application Publication
(10) Pub. No.: US 2023/0408399 A1
(43) Pub. Date: Dec. 21, 2023

(54) Optoacoustic Fluid Sensing Apparatus

(71) Applicants: ARISTOTLE UNIVERSITY OF THESSALONIKI - E.L.K.E., Thessaloniki (GR); HELMHOLTZ ZENTRUM MUNCHEN DEUTSCHES FORSCHUNGSZENTRUM FUR GESUNDHEIT UND UMWELT (GMBH), Neuherberg (DE)

(72) Inventors: Leonidas Ntziachristos, Trilofos Thessaloniki (GR); Nikolaos Kousias, Thessaloniki (GR); Vasilis Ntziachristos, Munchen (DE); Anastasios Kontses, Thessaloniki (GR); Antonios Stylogiannis, Munchen (DE)

(73) Assignees: ARISTOTLE UNIVERSITY OF THESSALONIKI - E.L.K.E., Thessaloniki (GR); HELMHOLTZ ZENTRUM MUNCHEN DEUTSCHES FORSCHUNGSZENTRUM FUR GESUNDHEIT UND UMWELT (GMBH), Neuherberg (DE)

(21) Appl. No.: 18/251,275

(22) PCT Filed: Oct. 29, 2021
(86) PCT No.: PCT/GR2021/000063

§ 371 Date: May 1, 2023

(30) Foreign Application Priority Data
Oct. 29, 2020 (GR) 20200100657

(51) Int. Cl. G01N 21/17; G01N 21/31

(52) U.S. Cl. CPC G01N 21/171; G01N 21/3103; G01N 2201/0221; G01N 2021/4704

(57) ABSTRACT

An apparatus for photo-acoustic measurement of a measurement target in a fluid flow comprises:—an ellipsoidal measurement chamber (3) having a first focal point and a second focal point; —a duct (6, 7, 8) configured to guide a fluid flow through the measurement chamber (3) along a first axis (X) through the first focal point; —light source means for generating an excitation light beam of modulated intensity; —means configured to pass the excitation light beam through the measurement chamber (3) along a second axis (Y), which is different from the first axis (X), such that the excitation light beam crosses the fluid flow at the first focal point and that the crossing of the fluid flow and the excitation light beam defines an excitation volume (4) within which the fluid flow is excited by the excitation light beam to generate acoustic waves; and —detecting means (5) arranged at the second focal point and configured to detect said acoustic waves, wherein the detecting means has no direct contact with the fluid flow, and wherein the ellipsoidal measurement chamber has inner walls that are configured to focus the acoustic waves generated by the excitation light beam within the excitation volume (4) onto the detecting means (5).

### FIELD OF THE INVENTION

The invention relates to an optoacoustic sensing apparatus with high sensitivity optical absorption comprising a light source, a sensor with a chamber and a detector, whereby signal is produced within the chamber by excitation light, notably for environmental applications.

### BACKGROUND OF THE INVENTION

Black Carbon referred to hereafter as BC has been associated with climatic effects due to its strong radiative forcing potential [1]. Despite of this, BC remains as a source of great uncertainty in relevant climatic calculations due to its largely unknown atmospheric distribution [2]. It is therefore of great importance to improve our understanding of its concentration in the atmosphere. A sensor that is able to economically measure the light absorption of BC particles would provide the ideal tool in this direction [3].

Such a sensor would also serve other needs. Combustion engines, used in vehicles, vessels, aircrafts but also in stationary applications, are the main sources of BC. In such cases, BC is formed in parallel to other gaseous and particulate species. In-use performance monitoring, utilizing proper sensors, is necessary to make sure that engines operate efficiently and fulfill the corresponding emission standards. For these applications, a sensor that could use the same operational principle to measure additional pollutants others than BC, such as nitrogen dioxide, carbon dioxide, sulfur oxides, or organic species would provide additional benefits in monitoring the emission sources performance.

Several optical methods have been used to measure BC particles, such as the aethalometer and the opacimeter [4]. The main disadvantage of such devices is that they cannot distinguish between light absorption and scattering, thus introducing an error to the measurement. Moreover, the opacimeter has limited sensitivity to nanometer-sized particles because they cannot efficiently extinct incident light, while the aethalometer requires a filter for BC deposition, thus altering the airborne BC characteristics before measurement and further increasing measurement uncertainty [5]. Also, the low sensitivity of such instruments requires long averaging times and cannot provide real-time measurement [6], thus limiting the applicability only in quasi steady concentration applications. Finally, other technologies like particle counters, resistive or charging sensors cannot isolate BC alone.

Applications based only on light absorption have been commercially used in several environmental applications to detect pollutants, including BC. The method requires a light source of suitable wavelengths to enable absorption by the species of interest. By modulating the light, the species in focus are periodically heated by absorbing the incident light and radiate the heat in the environment at the same frequency with the incident light. Detecting the intensity of generated heat waves by a temperature detector or the associated pressure waves by an acoustic detector allows the quantification of the abundance of the absorbing species.

### PRIOR ART

Most devices operating on light absorption employ a configuration where the species flow and the incident light beam follow the same path within a measuring cell, as for example in patents US006662627B2, US007710566B2 and US008115931B2. Usually, acoustic detectors are then used to measure acoustic waves produced by the optoacoustic phenomenon. The dimensions of the measuring cell are usually selected in a way that sound resonance, and thus signal amplification, is achieved. Sensitivity in such devices is prone even to slight temperature variations as the required sound amplification in the resonator changes with the temperature-dependent speed of sound.

Other known devices utilize mirrors to achieve multiple light passages through the species flow and thus lead to increased sensitivity, such as patents US008479559B2 and US008848191B2. There is also some limited use of acoustic mirrors to concentrate the acoustic signal at the acoustic sensor's location, as disclosed in patent US008115931B2, respectively applications US20090038375A1 and EP0464902A1. The need for sensitivity means that all optical and acoustic components are in or nearby the sample flow and are therefore prone to contamination by deposition of flow species. Complex flow pathways and/or secondary protective flows are therefore used to protect the sensitive components, e.g. in patent US008848191B2. Those increase the size, complexity and cost of the corresponding measurement devices, which is a drawback.

Document US 2008/121018 A1 of SCHOPP DONALD R et al of 29 May 2008 discloses a device that has an elliptically shaped chamber, with an excitation light oriented along the first focus of the chamber and an acoustic sensor along a second focus. The device can accommodate a trace gas that can be sensed.

EP 1 111 367 A2 of HONEYWELL INC of 27 Jun. 2001 discloses a device that uses the optoacoustic phenomenon to measure the concentration of gases. The device has a measurement chamber which is gas permeable and transparent to radiant energy, an acoustic transducer to detect acoustic energy and create electrical signals, and a temperature sensing means to generate temperature-dependent output. The acoustic transducer is mounted in a way that the pressure sensitive region is inside the chamber, while the region that has the electrical output is located outside the chamber. The device has significant differences with our system, as presented below.

DE 10 2006 048839 A1 of EADS DEUTSCHLAND gmbh [DE] MICRO HYBRID ELECTRONIC gmbh [DE]) of 24 Apr. 2008 discloses a device that has a measuring cell that can accommodate a medium to be measured, a radiation source and at least two photoacoustic cells connected to the measuring cell. The two photoacoustic cells can measure different gases, e.g. one can measure CO and the other can measure CO2. The measuring cell has a spherical or elliptical geometry so that it can reflect the generated radiation which should be able to reach all optoacoustic cells. Additionally, the cell can accommodate a second light source, which can be used to measure the concentration of smoke particles. The system described by the patent has significant differences with the system that is proposed by our patent, as described in the table below.

US 2016/061784 A1 of MADHAV KALAGA VENU [IN] discloses a device that has a body that contains a light source cavity, an optical device cavity, an ellipsoid cavity, a receiving device cavity and at least one channel that has one end disposed in the inner surface of the body. These four cavities and the channel are said to be aligned with respect to each other within the body of the device. The device receives a gas through the channel, the gas is excited by the light source, and it emits light and/or sound which is reflected at the walls of the ellipsoid cavity and reached the detector.

XP055462764 for “Fiber interferometer for hybrid optical and optoacoustic intravital microscopy”, doi 10.1364/OPTICA.4.001180 discloses a system that uses a light source to excite a specimen, the specimen producing an optoacoustic signal. The system also includes a chamber with an ellipsoidal shape that concentrates a significant part of the acoustic energy produced by the specimen, and an acoustic.

US 2006/263896 A1 of HOLLEBONE BRYAN R discloses a device that has a sampling medium to trap a contaminant from an aqueous fluid, a light source to excite the trapped contaminant leading to the emission of secondary radiation, said secondary radiation being either light or sound. The device also includes a detector to identify the secondary radiation, and a shell that refocuses the radiation from a first focal point, where it is generated, to a second focal point, where the detector is.

Document US 2007/085023 A1 of DEBROCHE CLAUDE [FR] et al of 19 Apr. 2007 discloses a device that uses a chamber, for which at least part is ellipsoidal, and which chamber can refocus light from a first focus point to a second focus point. The device also has a means of transporting a medium to be analysed and a means of transporting an excitation light beam both of which pass through the first focus point.

### AIM OF THE INVENTION

A configuration that increases the detection sensitivity without exposing sensitive components to species flow would thus be advantageous, as it would enable a simpler construction of such a sensor, reduce its size and cost, and thus allow for a portable and distributed use, as directed by current needs in automobile and environmental sensing. Successful implementation of such a portable sensor can also be considered in other applications, including measurements in fluids and biological measurements, for example measurements of various metabolites or blood components.

The invention aims to overcome the abovementioned drawbacks, notably consisting of the size and cost limitations of previous light absorbing methods, as well as further drawbacks thereof. The basic premise of the invention is to increase the sensitivity in detecting the energy produced on a measurement target in response to its excitation, using light of modulated intensity.

Said sensitivity increase is based on amplification techniques, as set out in the following. A central part of the invention is to provide a sensor with a chamber having a remarkable design.

### SUMMARY OF THE INVENTION

It is thus proposed according to the invention an apparatus defined for measuring a measurement target as comprising light source means, a measuring means with a chamber and detecting means, wherein said measuring means constituting a measuring cell consist of an optical absorption sensor. The chamber comprises ducting means to duct the flow of a fluid containing a measurement target and concentrates the energy produced in response to the excitation for detection, wherein said excitation is produced within an excitation volume, which is formed at the crossing of a beam generated by said light source means. The acoustic chamber has a curved shape that is such that the excitation volume is formed at a first focal point thereof and the detection area at its second focal point located at a distance d from said first point. Remarkably, said light source means is configured to generate an excitation beam of modulated intensity and in that the said detector means is configured to detect an acoustic signal, whereby a signal is produced within the chamber by excitation light, with the flow of said measurement target MT in their intersection with said beam.

The flow path has a first axis X that is defined by a sample inlet and a sample outlet for the sample flow, whereas the light beam has a second axis Y that is defined by a light inlet and an exit windows for the light passage, by which the species flow MT and the incident light beam follow a mutually different optical path according to said X-, resp. Y-direction, within said. The excitation produces energy comprising a thermal and an acoustic component, either of which is sensed by said detecting means.

Said acoustic chamber focuses said sample flow MT to a remote detection means over said distance from said first point F₁ of said excitation volume thereby avoiding a direct contact between the particles in said sample flow and the detector, by virtue whereof the sensitivity in detecting the energy produced on a measurement target MT in response to its excitation, is increased using light of modulated intensity.

According to a further embodiment of the apparatus of the invention for measuring a measurement target MT, said chamber has an ellipsoidal shape with a first focal point F₁ and a second focal point F₂, wherein said guiding means guide a gas flow across the first focal point F₁ along said X axis. Said light beam and measurement target flow define an intersection volume that allows excitation of said measurement target, wherein said intersection volume forms said excitation volume of said measurement target flow by the light beam at their intersection. Said ellipsoid acoustic chamber has said excitation volume located at its first ellipsis focal point corresponding to said first point F₁ and the detection area located at its second ellipsis focal point corresponding to said second point F₂. Said ellipsoid chamber concentrates acoustic energy, which is generated at the said excitation volume in response to the light of modulated intensity, and focuses said acoustic energy to a remote sound detection area corresponding to said second point F₂ located at a distance d from said first point F₁ of said excitation volume along a third axis Z. Said two axes X, Y are mutually positioned with a certain angle to each other thus forming a plane α, which said third axis Z does not belong to. Said second point F₂ defines a sound detection area, wherein said detector is located to detect the energy generated in response to the light of modulated intensity, wherein said acoustic detector is located away from the incoming measurement target pollutant flow, being remote at said distance therefrom.

The specific geometry of the chamber allows to refocus sound leading to an optoacoustic detection, instead of the chamber being used to refocus light leading to optical detection as in US 2007/085023 A1; whereas the sample configuration consists of a flow along one axis without any circulation. The flow spends minimum time in the ellipsoidal chamber instead of the known system having a sample configuration wherein the circulation of medium along a path passing through the first focus point wherein the medium that will be measured is positioned in a case (specimen), matching the shape of the chamber. Thus, there is no flow in and out of the chamber.

Besides, in the device according to the invention, an optoacoustic detection is applied instead of an optical fluorescent analysis of contaminants; and there is no trapping medium as in US 2006/263896 A1. The device is designed to minimize the deposition of the contaminants to be measured instead of the known use of a trapping medium to trap and detect the contaminant.

Moreover, in the device according to the invention, the concentration of contaminants in a flow is measured and determined, whereas the system in XP055462764 is an add-on to optical microscopes, and it uses a specimen to produce the optoacoustic signal and detect the contaminants. According to the invention, the sample flows inside the chamber. The optics, the acoustic detector and the chamber are then protected from contamination with several ways: through an optical path perpendicular to incoming pollutant flow; the detector is located away from the flow path and through thermo-repulsion, a mild positive thermal gradient is maintained between the pollutant path and the sensitive elements; instead of having no contact between the chamber and specimen. A thin light and sound-permeable layer physically separates them. To assure proper propagation of the sound through the thin film, the chamber is filled with a fluid with specific properties.

The apparatus of the invention thus comprises a light source with a sensor for measuring a measurement target MT, and further:
an optoacoustic sensor having a chamber with a shape that establishes a first axis X for a measurement target MT flow and a second axis Y for a light beam of modulated intensity; said two axes X, Y are positioned at a certain angle to each other, thus forming a plane;
said light beam and said MT flow define an intersection volume that allows excitation of said measurement target MT; wherein said volume forms an excitation volume of said MT flow by the light beam at their intersection;
said chamber contains the energy which is generated in response to said excitation so that it can be interrogated by a detector;
said chamber's shape has a geometry that concentrates and focuses acoustic energy which is generated at the excitation volume in response to the light of modulated intensity to a remote sound detection area corresponding to a second point located at a distance from a first point of said excitation volume along a third axis Z not belonging to said plane;
said second point comprises a sound detection area, wherein a detector is located to detect the energy generated in response to the light of modulated intensity.

Said chamber thus encompasses three axes, allowing in a first axis X a flow of measurement target, in a second axis Y the direction of incident light of modulated intensity and in a third axis Z, the detection of the corresponding energy produced. Said first measurement target flow central axis X and said second central axis Y of the incident light of modulated intensity are directed so as to form a plane. Both said axes mutually form an angle to each other, also allowing for the inclusion of additional axes, if required, for measuring optical properties of the measurement target. The chamber geometry facilitates protection of the optics and detectors, by decomposing the first and second axes of the flow path and the light beam(s) X, Y respectively. Therefore, in the apparatus according to the invention, the species flow and incident light beam follow a mutually different path within said chamber as measuring cell of the apparatus. Measurement amplification enables the use of cheap light sources, such as laser diodes.

Measurement target referred to herein as MT means herein the fluid flow through the chamber that is excited by incident light beam(s) under different paths, up to orthogonal, under 90° C. Said MT could be flue or exhaust gas from any emission source, ambient air or a solute of molecules, including biomolecules. The fluid may contain different pollutants, including black carbon or other particles, gases such as nitrogen oxides, carbon dioxide, sulfur oxides, and others that need to be detected by the sensor, notably to determine air quality. Said MT could also be a portion of the entirety of the exhaust of an engine or of flue gas of other combustion activity, such as exhaust and flue gases produced by transport devices, like vehicles, vessels, trains, airplanes, etc. or industrial activities like combustors, incinerators, boilers, etc.

The apparatus according to the invention thus comprises a sensor with a chamber in which the MT enters. The excitation volume in the chamber is formed by the crossing at the intersection of the first MT flow axis X and the second axis Y of incident light of modulated frequency beam.

In a particular embodiment of the apparatus according to the invention, said axes X, Y, Z are perpendicular to each other, which appears to be more efficient notably from a trigonometric point of view. However, other relative angles can be foreseen as well.

Thanks to the chamber of the apparatus according to the invention, the MT flow is enabled, as well as the excitation of the MT by the modulated incident light and a configuration whereby the energy derived from the excitation of the MT is contained and concentrated allowing to perform an effective measurement with high sensitivity. The energy produced by incident light excitation on the MT contains a thermal component, with slight increase of local temperature, and an acoustic component, with the generation of an ultrasound wave, that is detected along said third axis Z in the chamber. Both thermal and acoustic energies relate to the amount of light energy incident to the excitation volume and the quantity of absorbing species present in the MT.

Thanks to the invention, the chamber concentrates said acoustic component of the energy generated corresponding to sound and it refocuses the sound generated at the excitation volume to a remote sound detection area along the third axis, on which the acoustic detector is located. The reliability of signal detection is thus increased thanks to pollutant contamination of the optics and the acoustic detector being avoided, which is achieved since they are both located away from the pollutant flow being remote therefrom at a certain distance. Moreover, refocusing sound at low frequencies, 10-200 kHz, results in a relatively large acoustic focal area, of the order of mm, which means that sensitivity is not dependent on the exact positioning of the acoustic detector or on external vibrations. Therefore, with the concentration of sound, the avoidance of contamination and the relaxed requirements in terms of acoustic sensor positioning achieved thanks to the invention, cheap light sources such as laser diodes, can be used to generate light, while maintaining the needed sensitivity. With the use of a chamber in the apparatus according to the invention instead of a resonator according to the prior art, the speed of sound and hence, the temperature of the sample do not have an important effect on the output signal. Moreover, a chamber may provide several degrees of freedom for combining various optoacoustic with optical detection methods to better characterize MT properties.

In a preferred embodiment of the apparatus according to the invention, said chamber has an ellipsoid shape as the preferred geometry providing a passive concentration of sound and refocusing same. Such a geometry allows for adequate distancing, particularly in the mm to cm range, between the excitation volume, which is located at the first focal point F₁ of the ellipsoid, and the detection volume, which is located at the second ellipsoid focal point F₂. In an ellipsoid, the acoustic energy generated at the excitation volume travels the same distance by reflection in all directions on the ellipsoid walls to reach the detection volume; thus sound is concentrated and refocused away from the excitation volume. The ellipsoid also provides enough space and wall area to evaluate optical scattering from the sample along additional axes in different angles.

Thanks to this specific shape of the chamber, the abovementioned effects of established distancing between both focal points F₁ and F₂ of said ellipsoid is even more enhanced by elongating it by increasing its characteristic axis ratio a/b possibly beyond 1.5 to 4, wherein a is the major axis and b is the small one.

In a further preferred embodiment of the device according to the invention, the sensing apparatus comprises laser diodes or Light Emitting Diodes referred to hereafter as LD, respectively LED, as low cost and compact light sources. Additionally, said LDs and LEDs can be driven with very high repetition rates—duty cycles—, that allows for improved SNR through averaging without increasing the acquisition time.

The said LDs or LEDs, as current-driven devices, can be modulated using different waveforms, such as sine waves, square pulses with different duty cycles and repetition rates, a frequency comb, triangular pulse.

According to a still further preferred embodiment of the invention, fiber power combiners are provided so as to combine the output of different light sources into a single fiber in order to keep the size of the sensor small and not use multiple acoustic chambers for different wavelengths. Fiber combiners present high coupling efficiency, up to >98%, therefore not limiting the sensor's sensitivity.

Clever modulation and coding techniques, such as the Golay Codes, can be applied in order to simultaneously excite the sample with all the selected wavelengths and later disentangle the respective signals. In this way, the sensor signal acquisition rate can be increased.

As to acoustic detector, sound detection along the third axis Z of the chamber is based in any sensitive kHz implementation including a quartz tuning fork referred to hereafter as QTF, possibly also a microphone, MEMS or other piezoelectric detector, or optical detection of sound as elaborated in [8]. In a particular embodiment of the device according to the invention, the detector is a QTF, which is responsive only on narrow bands of acoustic frequencies—main frequency and its harmonics—, thus delivering a high Q-factor. The QTF is expected to deliver a high signal to noise ratio because of its inherent characteristics, thus increasing the sensitivity, even using low power light sources, that is without current overdriving.

The present invention also relates to a method for high sensitivity optical absorption sensing for environmental applications, esp. for carrying out the device set out above notably including a thermal detector.

Optical detection of the temperature gradient along the third axis Z is the preferred method to measure the thermal component of the energy produced at the MT. The energy dissipated by the absorbing species at the MT, following their excitation by the modulated light incident beam, produces a temperature gradient along the third detection axis Z. This local temperature increase is measured by means of reading the heat-induced index of refraction changes in response to excitations, as also captured in [8], [9].

In such an embodiment, an optical beam of light of different wavelength of the modulated incident light is targeted along the third axis Z in the vicinity of the excitation volume and a photosensing element is located on the opposite wall of the chamber along the beam axis. The deflection of the beam as a result of the local temperature difference and the corresponding change of the refraction index at the MT vicinity results in a decrease of the light sensed by the photosensing element. The decrease in light intensity sensed is then linked to the quantity of light absorbing species at the MT.

As to sensor sensitivity, by adjusting the pulse width, the repetition rate of the pulse train, the parameters of the frequency comb, or other parameters of the modulation function, the sensor's sensitivity can be further improved according to a further advantageous embodiment of the invention. The excitation volume can also be optimized for maximum SNR, high sensitivity and low detection limit of the sensor. The excitation volume can be adjusted by modifying the cross-section of the MT flow, the flowrate of the MT flow, the cross-section of the modulated light beam and the angle of the two axes formed. The MT flow cross-section can be increased by properly sizing the inlet and outlet of the sensor for the MT flow. Increasing the two openings, inlet and outlet, is also used to increase the flowrate which results in more absorbing species per unit of time brought in the excitation volume.

Ideally, the cross-section of the MT flow and the light beam should have the same diameters where they cross each other. For a higher cross-section of the MT flow, a wider beam for the incident light is required. With an appropriate choice of collimation and focusing optics, the shape of the laser beam on the excitation volume can vary from a small, tightly focused point to a large collimated beam. The spatial shape and time modulation waveforms are selected so that the sensor's sensitivity is maximum and the detection limit low.

According to a still further embodiment of the invention, the correct choice of the chamber wall material to improve the sensitivity consists of thin, high-density solid walls offering such characteristics for optimal sound reflection and minimum transmission and absorption of incident waves. High-density plastic can offer a good compromise between low material cost and high sound reflection. Metals, such as steel, aluminum and bronze, offer advanced sound reflection but may entail higher manufacturing costs. Metal plating of the plastic wall offers decreased costs and enhanced sound reflection properties.

Sensitivity is also increased by improving the signal to noise ratio. According to a still further preferred embodiment of the invention, this can also be achieved by arranging two sensors in parallel with the first sensor in normal operation and the second one with its MT fluid flow blocked to the species for which the first sensor produces a signal. In particular, the second sensor is equipped with a device to remove black carbon before this reaches the excitation volume. The signal of the second sensor can be used to improve the measured signal from the first sensor, with known signal correction techniques, including interference bias notably from environmental pollutants or cross-interference, offset and linearity corrections.

In a yet further embodiment of the method according to the invention, an optical monitoring of measurement target is proposed, wherein when particles or gases are illuminated, light gets both absorbed and scattered. Optoacoustic detection is responsive only to light absorption which makes it ideal for BC identification. Light detection in 180° is sensitive to both absorption and scattering, while detection in other angles, e.g. 45° or 90°, is only sensitive to scattering. Now, thanks to its specific geometry, the sensor according to the invention may combine both optoacoustic detection and detection of scattered light in various angles between ˜0° and 180° stereoscopic. In particular for particles, this allows obtaining information for particle size and potentially non-carbonaceous composition in addition to BC mass. For this purpose, the sensor can utilize fibers to guide the light scattered in different angles in sensitive photodetectors. The scattering angle distribution of the light depends on the size distribution of the particles that the light illuminates. According to the scattering theories of Mie, Rayleigh or Rayleigh-Debye-Gans, a particle size distribution can be derived, so as to yield the required identification data accordingly.

As to decrease of contamination, keeping clean optics and a clean sound detector is essential to maintain long-term sensor durability. Besides, accumulation of particles from MT flow notably on the optical path will decrease light sensitivity, while accumulation on the sound detector will change its natural frequency. Long term operation is naturally achieved by locating the sensitive components away from the MT flow path. Thanks to the apparatus according to the invention, the acoustic detector is by design located away from the incoming MT pollutant flow. The optical path is also by design perpendicular to said MT pollutant flow to avoid the optics coming close to pollutant contaminants.

According to a further advantageous embodiment according to the invention, to further avoid contaminants deposition by buoyancy and natural convection, a mild positive thermal gradient is maintained between the pollutant path and the sensitive elements to enable further protection by thermo-repulsion. An acoustically transparent but particle non-permeable material can be used to separate the acoustic detector from the MT flow to protect it from contamination.

As to Measurement Target flowrate, it is to be represented that the chamber involves a minimum resistance to the MT flow.

In another embodiment of the method according to the invention, the measurement of the thermal component of the energy produced in the excitation volume is conducted along the third axis. This can be achieved by a thermal detector by inferring the temperature variation in the vicinity of the MT due to the modulated energy of the incident light, further set out below. By introducing optical detection of temperature variation along this third axis, relevant optics again remain at a distance from the MT and along an axis forming an angle with the MT flow axis. This again serves protection of the optics from contamination. Moreover, the measurement of the thermal component of the produced energy at the vicinity of the MT is expected to lead to increased sensitivity over optoacoustic sensors, as the acoustic energy is known to be only a fraction of the thermal energy produced.

As to multi-wavelength illumination and spectral separation, the different absorbers and pollutant species can later be separated using spectral un-mixing methods. The Optoacoustic signal is proportional to the excitation energy of the laser source, the absorption value of the species in MT and the concentration of these spices:

$${S}_{λ} = {I}_{λ} {\sum }_{i}^{n} {μ}_{λ}^{i} {C}_{i}$$

where S_{λ} is the optoacoustic signal of the laser source with wavelength λ, I_{λ} is the optical energy of the laser source with wavelength λ, μ_{λ}ⁱ the absorption of the gas or particulate i at wavelength λ and Cᵢ the concentration of the i-th gas or particulate in the MT. Therefore, a system of n equations of n unknowns is formed that can be easily solved analytically to determine the concentration of the n pollutant gases or particulates in the MT, as long as there are n wavelengths.

Laser diodes and LEDs are available in many wavelengths, covering the range from the UV, the visible and the NIR (˜300 nm up to ˜1500 nm). The different wavelengths will excite different gases such as NO₂ (350 nm-600 nm), black and brown carbon particles (mainly in the visible and NIR spectrum), CO₂ (˜1400 nm), SO₂ (˜300-320 nm). The different absorbers, pollutant gases and particulates, can later be separated using the above mentioned spectral unmixing methods. Thanks to this further preferred method according to the invention, the sensor is able to detect and monitor in real time multiple gases and light-absorbing particulate species simultaneously.

The sensor's multiple signals can be used to evaluate a broad number of the sample's characteristics. The optoacoustic signal provides the mass concentration of certain gas and particulate species as described before. By additionally monitoring light scattering in different angles, the size distribution of the particles can be calculated. Many theories can be used to achieve that information, namely Rayleigh scattering for nanometer-sized particles, Mie theory for micrometer-sized (spherical) particles, as well as Rayleigh-Debye-Gans theory for particle agglomerates. Also, the ratio of absorption to scattering in different angles and excitation wavelengths will be used to estimate the gas sample component concentrations and distinguish different absorbers, such as NO₂, BC or other carbonaceous particles, CO₂, SO₂, dust, ash etc.

Proper electronics circuitry will be integrated on the sensor to drive the laser diodes, to amplify the detected optoacoustic signal, to digitize and acquire the optical as well as the optoacoustic signals, process them and transmit them to a collection and data storage point. In order to achieve this, microprocessors such as Arduino, field programmable gate arrays (FPGA), analog to digital converters (ADC), operational and trans-impedance amplifiers, Bluetooth or other transmitting technologies can be used.

Further particularities and characteristics of the invention are defined in the further sub-claims. In addition in the invention, 3 separate axes are used for the flow referred as channel herein, the light beam and the detector. Flow and light intersect at one of the focus points of the ellipsoidal chamber forming the excitation volume, whereas in US 2016/061784A1 flow, light beam and detection are linearly aligned. The gas is injected between the two focus points of the ellipsoidal cavity; the light beam is spatially modulated before it enters the sensor, whereas a light source and an optical device cavity are included in the latter document.

Further in the invention, there is one optoacoustic cell with one detector. Multiple pollutants can be measured with one detector by using 2 or more wavelengths simultaneously and identifying the absorption from each one, whereas in DE 10 2006 048839 A1 there are at least two separate optoacoustic cells to measure two pollutants at the same time. The elliptical shape is used to refocus the acoustic energy that is generated by the excitation radiation, whereas in the latter, the spherical or elliptical shape is used to distribute the excitation radiation light to a multitude of optoacoustic cells. Three separate axes are used for the flow path, the light beam, and the detection.

The optics, the acoustic detector and the chamber are protected from contamination with the following ways: optical path perpendicular to incoming pollutant flow, the detector is located away from the flow path, and thermo-repulsion: a mild positive thermal gradient is maintained between the pollutant path and the sensitive elements, whereas in the latter, there are no measures to avoid contamination of the ellipsoid/spherical chamber.

At last, the invention provides capability for detection of both gaseous and particulate pollutants; solid wall, with inlet and outlet tubes/paths that allow for the sample fluid and the excitation light beam to enter and exit the chamber; ellipsoid-shaped chamber to refocus the sound; three separate axes are used for the flow, the excitation light beam and the detector. Also, to avoid contamination the optics, the acoustic detector and the chamber are protected from contamination with the following ways: optical path perpendicular to incoming pollutant flow and the detector is located away from the flow path; thermo-repulsion: a mild positive thermal gradient is maintained between the pollutant path and the sensitive elements.

The method and apparatus of the invention is further illustrated by the enclosed drawings, in which further details explained in more detail are in the following description, in some embodiments of the invention with reference to the attached drawings.

### BRIEF DESCRIPTION OF THE DRAWINGS

FIG. 1 is a prospective view of an embodiment of the optoacoustic apparatus with sensor of the present invention;

FIG. 2 is a sectional view of an enlarged representation of the apparatus with sensor of FIG. 1 taken along the line A-A;

FIG. 3 is a sectional view of the apparatus with sensor of FIG. 1 taken along the plane B-B;

FIG. 4 is a detail of an implementation of the light beam, in an apparatus with sensor;

FIG. 5 is a sectional view of an embodiment of the optoacoustic apparatus with sensor of the present invention where the sensor is used for the measurement of pollutants in an exhaust line;

FIG. 6 is a sectional view in 90 degrees angle difference to the embodiment according to the invention of FIG. 5;

FIG. 7 is a schematic plan view of an embodiment according to the invention using two sensors in parallel to increase sensitivity.

### DESCRIPTION

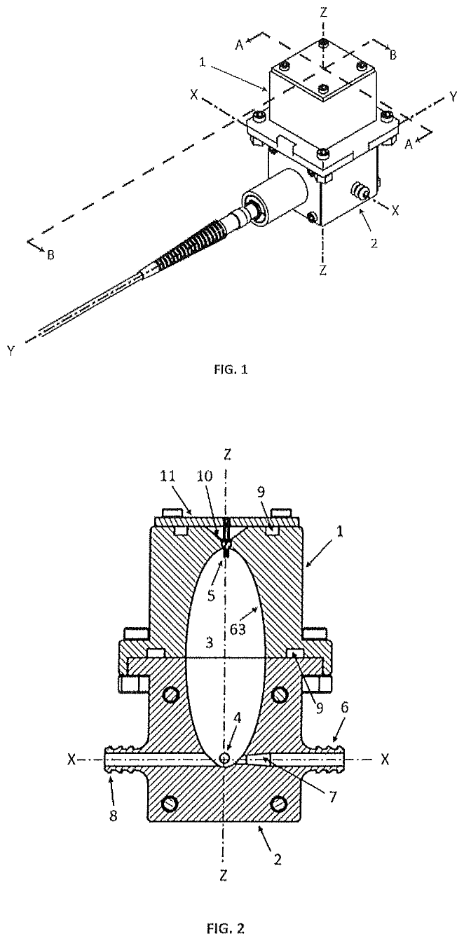

The invention relates to an optoacoustic apparatus with high sensitivity optical absorption sensor and its use for environmental applications, a first embodiment whereof is shown in FIG. 1, wherein the sensitivity in detecting the energy produced on a measurement target in response to its excitation is increased, using light of modulated intensity. The sensitivity increase is based on amplification techniques, as explained in the following.

Said apparatus comprises a sensor 44 provided with a chamber 3 having a remarkable design, which encompasses three axes X, Y, Z, allowing in a first axis X the flow of said measurement target, in a second axis Y showing the direction of incident light of modulated intensity, and in a third axis Z the detection of the corresponding energy produced. Said measurement target flow central axis X and said central axis Y of the incident light of modulated intensity are directed so as to form a plane α. Said axes X, Y are at different angles to each other, also allowing for the inclusion of additional axes Z, as required for measuring optical properties of the measurement target. The chamber geometry provides protection of the optics and detectors 5 which are sheltered therein, by decomposing the axes X of the measurement target flow path MT and Y of light beam(s) 19. Measurement amplification enables the use of cheap light sources, such as laser diodes 21, 22.

Measurement target MT means herein the fluid flow containing a quantity of absorbing species present in the MT passing through the chamber 3 that is excited by the incident light beam(s) 19. Said MT could be flue or exhaust gas from any emission source, ambient air or a solute of molecules, including biomolecules. The fluid may contain different pollutants, such as black carbon or other particles, nitrogen oxides, carbon dioxide, sulfur oxides, and others that need to be detected by said sensor to determine air quality. Said MT may also be a portion of the entirety of the exhaust of an engine or of flue gas of other combustion activity, such as exhaust and flue gases produced by transport devices, like vehicles, vessels, trains, airplanes, etc. or industrial activities like combustors, incinerators, boilers, etc.

The sensor 44 has the chamber 3 where the MT enters. The excitation volume 4 in the chamber 3 is formed by the crossing of the MT flow axis X and the different axis Y of incident light of modulated frequency beam 19, at their intersection, wherein they form an angle. Preferably these axes X, Y are perpendicular to each other. However, other relative angles can be foreseen as well. The purpose of the chamber 3 is to enable the MT flow and the excitation of the MT by the modulated incident light, as well as to provide a configuration whereby the energy derived from the excitation of the MT is contained or concentrated in order to achieve an effective measurement with high sensitivity. The energy produced by incident light excitation on the MT contains a thermal component representing a slight increase of local temperature, and an acoustic component corresponding to the generation of an ultrasound wave, that is detected along the third axis Z in the chamber 3. Both thermal and acoustic energies relate to the amount of light energy incident to the excitation volume 4 and the quantity of absorbing species present in the MT. This relation is described in published literature by the thermoacoustic equation—optoacoustic, photoacoustic—, or as the photothermal equation—photothermal heat generation—.

The chamber 3 concentrates the acoustic component of energy generated sound and refocuses this sound generated at the excitation volume 4, to a remote sound detection area 5 along the third axis Z, where the acoustic detector 5 is located. It is thus expected to increase the reliability of signal detection, due to avoidance of pollutant contamination of the optics and the acoustic detector 5, since they are both located away from the pollutant flow. Moreover, refocusing sound at low frequencies, 10-200 kHz, results in a relatively large acoustic focal area, of the order of mm, which means that sensitivity is not dependent on the exact positioning of the acoustic detector 5 or to external vibrations, thus alleviating the operating requirements. Said concentration of sound, said avoidance of contamination and the relaxed requirements in terms of acoustic sensor positioning set out above entail that cheap light sources, such as laser diodes, are good enough to generate light while maintaining the needed sensitivity. With the use of a chamber 3 instead of a resonator, the speed of sound and hence, the temperature of the sample, does not have an important effect on the output signal, in contrast with the commonly used resonator. Moreover, a chamber may provide several degrees of freedom for combining various optoacoustic with optical detection methods to better characterize MT properties.

An ellipsoid chamber 3 is selected as the preferred geometry to achieve passive concentration and refocusing of sound. In addition, such a geometry is characterised by two mutually remote focal points F₁, F₂, which allows for an adequate distance in the mm to cm range between the excitation volume 4 located at the first focal point F₁, and the detection volume 5 located at the second focal point F₂. In an ellipsoid, the acoustic energy generated at the excitation volume 4 travels over the same distance by reflection in all directions on the ellipsoid walls 63 to reach the detection volume 5; sound is thus concentrated and refocused away from the excitation volume 4. The ellipsoid also provides enough space and wall area to evaluate optical scattering from the sample along additional axes in different angles.

In another embodiment, the measurement of the thermal component of the energy produced in the excitation volume 4 is conducted along the third axis Z. This can be achieved by a thermal detector by inferring the temperature variation in the vicinity of the MT due to the modulated energy of the incident light, as further set out below. By introducing optical detection of temperature variation along this third axis Z, relevant optics again remain at a distance from the MT and along an axis Y forming an angle with the MT flow axis X. This again serves as protection of the optics from contamination. Moreover, the measurement of the thermal component of the produced energy at the vicinity of the MT is expected to lead to an increased sensitivity over optoacoustic sensors, as the acoustic energy is only a fraction of the thermal energy produced.

The sensing apparatus preferentially utilizes low cost and compact light sources such as laser diodes LD 21, 22 or Light Emitting Diodes LED respectively. LDs and LEDs, although small in size and low cost, usually suffer from low output peak power. However, LDs can also be overdriven with up to 40-fold higher current than their continuous wave referred to as CW absolute maximum value, for only a few nanoseconds, providing up to 30-fold higher peak power than their CW absolute maximum rating, without getting damaged. In this way, the delivered power can be increased, and the SNR can be improved, therefore the sensor's sensitivity as well [7]. Additionally, the LDs and LEDs can be driven with very high repetition rates—duty cycles—, that allows for improved SNR through averaging without increasing the acquisition time.

In order to keep the size of the sensing apparatus small and not to use multiple acoustic chambers 3 for different wavelengths, fiber power combiners 27 are incorporated so as to combine the output of different light sources 21, 22 into a single fiber. Fiber combiners 27 present high coupling efficiency up to >98%, therefore not limiting the sensor's sensitivity.

LDs or LEDs, as current-driven devices, can be modulated using different waveforms, such as sine waves, square pulses with different duty cycles and repetition rates, a frequency comb, triangular pulse.

Clever modulation and coding techniques, such as the Golay Codes, can be applied in order to simultaneously excite the sample with all the selected wavelengths and later disentangle the respective signals. In this way the sensor signal acquisition rate can be increased.

As to acoustic detector, sound detection along the third axis Z of the chamber 3 can be based in any sensitive kHz implementation including a so-called quartz tuning fork referred to hereafter as QTF, a microphone, MEMS or other piezoelectric detector, or optical detection of sound as elaborated in [8].

In a first embodiment of the sensing apparatus, the detector 5 is a QTF, which is responsive only on narrow bands of acoustic frequencies—main frequency and its harmonics—, thus delivering a high Q-factor. The QTF is expected to deliver a high signal to noise ratio because of its inherent characteristics, thus increasing the sensitivity even using low power light sources, i.e. without current overdriving.

In another embodiment of the sensing apparatus, a sensitive microphone, which can detect all frequencies that derive from an overdriven light source, is used as acoustic detector 5. High sensitivity is then achieved by the relatively high acoustic energy produced by the overdriven light source 21, 22. The microphone selected should be sensitive to the frequency of modulated light and its harmonics produced at the MT, and insensitive to sound frequencies of the environment that the sensor 44 operates at.

FIG. 1 shows a perspective schematic of an embodiment of the optoacoustic sensor 44. It comprises two casing halves 1, 2 having both the same recess so as to enclose a chamber 3 formed inside it, with an ellipsoid profile. One of the halves 1 provides for the positioning of the acoustic detector 5. The other half 2 provides for the positioning of the light source 21, 22, the transmission of the light beam 19 and the flow of the measurement target MT. The axes Y, X of the light beam 19 and the measurement target MT respectively are preferably perpendicular to each other and form a plane α. The intersection of the two axes X, Y forms the excitation volume 4 which, together with the point of acoustic detector location F₂ form third axis Z of chamber 3.

A cross-section of the said ellipsoid chamber 3 is shown in FIG. 2 along the A-A plane of FIG. 1. The chamber 3 is formed by proper hollow shaping of the two casing halves 1 and 2, preferably as two identical half ellipsoid recesses. These are made of plastic for low temperature applications or metal, or even another material, e.g. ceramic, for higher temperature applications. Proper sealing of said two halves 1, 2 is achieved using an O-ring 9 of elastomer, copper, or any other suitable material.

The measurement target MT is introduced in the chamber 3 by entering through inlet 6 and exiting through outlet 8. The inlet pipe 6 contains a proper accelerating section 7 getting narrower downstream, e.g. linearly for the MT flow in progress according to arrow F and a smoothened rim 76 just before this enters the chamber, i.e. upstream therefrom. This allows to accelerate and focus the measurement target MT flow to reduce particle loss by diffusion on the walls 63 thereof and to give it the same diameter with the light beam 19 where they cross each other, at their intersection in F₁. This results in that the sample flow remains in the sensor's chamber 3 for a short time only, which minimizes particle deposition thereon. The measurement target MT crosses the light beam 19, which is perpendicular to the measurement target flow, at the first focal point F₁ of the ellipsoid. The intersection of the two axes X, Y forms the excitation volume 4 which, together with the point of acoustic detector location F₂, form the third axis Z of the chamber 3. The acoustic energy produced by the optoacoustic phenomenon at the excitation volume 4 is refocused by the ellipsoid chamber 3 to the second focal point F₂ of the ellipsoid where a QTF is located as acoustic detector 5. Said QTF is held at position, using a conical section 10 that allows easier assembling. The second focal point F₂ location is determined within several hundreds of micrometers, resulting in that precisely locating the QTF is not a requirement. An electronic circuit 11, which is used to capture the QTF's signal, is located on top of the sensor 47. An O-ring 9 is also used there for tightly sealing both casing halves 1, 2 in perfect alignment of the corresponding recessed shells of said sensor 44.

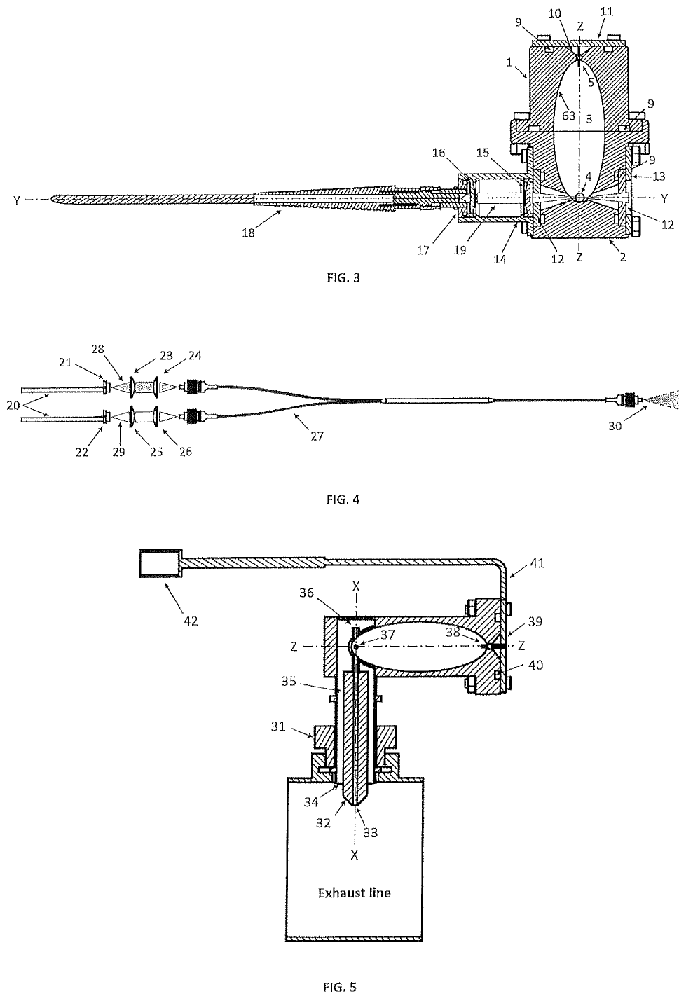

FIG. 3 shows a sensor cross-section along plane B-B of FIG. 1, which is at an angle of 90 degrees compared to the cross-section of FIG. 2 showing the path of the light beam 19. An optical fiber 18 transfers the light from the light source 21, 22 to the optical path of the sensor 44. Transparent windows 12 made of glass are used to allow the light to travel in and out of the sensor 44. A set of lenses 15, 16 are used to focus the light beam 19 to the first focal point F₁ of the ellipsoid. The light beam diameter starts increasing when it exits the optical fiber 18 until it meets the first lens 16. The first lens 16 collimates the light beam 19 before it reaches the second lens 15, i.e. the second lens focuses the light beam 19 so that it has the proper diameter when it reaches the excitation volume 4. The diameter of the cross section of the focused beam at the location of the excitation volume 4 depends on the modulation frequency of the light, in order to achieve maximum sensitivity. Moreover, focusing of the beam 19 by lens 15 helps in reducing the amount of light that is lost at the walls 63 of the sensor 44 causing background acoustic noise. The light beam 19 may comprise more than one light source 21, 22, i.e. wave lengths, carried by the same optical fiber 18 to allow detection of more than one species of the measurement target.

A hollow cap 13 is used to hold the glass windows 12 in place on the side where the light exits the chamber 3 while O-rings 9 are sealing these glass windows. A second cap 14 holds the glass at the inlet of the light beam 19. That cap 14 also accommodates the two lenses 15, 16, which provide a proper space modulation of the light beam 19. A fiber connector adapter 17, which allows the optical fiber to be integrated with SM-threaded components, is also screwed on an SM-thread of the second cap 14, in a very small distance from the second lens 16. An optical fiber 18, which carries the light beam 19, is finally connected to the fiber connector adapter 17.

The use of an optical fiber 18 allows flexibility wherein the light source 21, 22 is located in relation to the sensor body. This may be needed for example where the sensor 44 operates in a high temperature environment or where the light source 21, 22 should be otherwise protected. There is an additional reason for using an optical fiber, which consists of the possibility to combine more than one light source 21, 22, for example at different wavelengths λᵢ, for detection of different species. FIG. 4 shows how the light from two different sources 21, 22 enters the fiber 18 for being transferred to the sensor 44. Two Laser Diodes 21, 22 at different wavelengths λ₁, λ₂ are used as light sources in that exemplary embodiment. The Laser Diodes are connected to electronic circuitry 20 which modulates their output. A twin set of two lenses 23/24, 25/26 couples the light beams 28, 29 to a 1×2 fiber optic coupler 27. The fiber optic coupler 27 produces a mixed light beam 30, which contains both wavelengths λ₁, λ₂.

FIG. 5 illustrates a second exemplary embodiment of the sensor, wherein it is configured for installation in a vehicle's exhaust line or in an industrial stack for flue gases. The sensing part of the sensor is identical to the one presented in FIGS. 1 to 3. However, the measurement target MT flow path upstream of the sensor is changed to allow resistance of the sensor to high temperatures and a self-induced flow for the measurement target (exhaust or flue gases). The sensor is held on said exhaust line or stack by means of a retaining screw 31, e.g. of an M20 size, similar to the one used for automotive exhaust sensors today. The desired flowrate through the sensor is created by a tip 32 which employs the Bernoulli principle. Based on this, the forced motion of the exhaust or flue gas in said exhaust line or stack, respectively, creates an underpressure at tip outlet 33. This creates a flowrate of the exhaust gas through an inlet 34, which travels in a sleeve 35 and enters the sensor chamber 3 through an inlet 36. An ellipsoid chamber as in FIGS. 1, 2 and 3 is used as well in this case. Thanks to this remarkable configuration, the sound waves created in the first focal point 37 are refocused therein where the light beam is focused to the QTF placed in the second focal point 38. Again, the latter is located away from the pollutant source to avoid contamination of QTF as sensitive material. An electronic circuit 39 is used again to capture the signal. An O-ring 40 is used for sealing the sensor.

FIG. 6 shows the same embodiment in a cross-section perpendicular to the plane of FIG. 5. In this section, the path of the light beam is illustrated. An optical fiber 43 transfers the light from the light source to the sensor inlet 34. The harness 42 for the optical fiber 43 may also carry the wiring for the sensor signals 41. In this way, the light sources and the electronics box are at a distance from the sensor to avoid impacts of vibration and temperature, as well as connection flexibility to the signal's bus of the vehicle or the industrial plant where the sensor is installed.

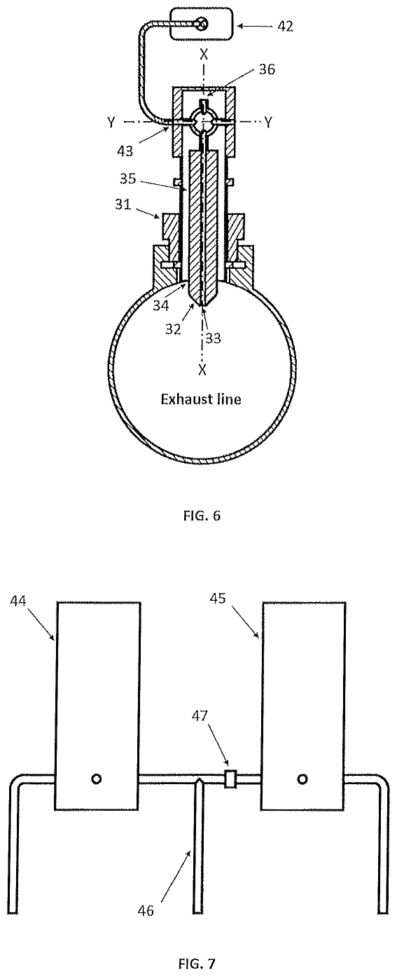

Finally, FIG. 7 shows a third exemplary embodiment where two identical sensors 44, 45 are used in a differential way. This configuration assists in improving the sensitivity, in particular for black carbon. First sensor 44 and second sensor 45 receive the measurement target sample from a common inlet line 46. A high efficiency particulate air filter 47 is used upstream of second sensor 45 in order to filter out all particulate matter, including black carbon, before such species enters the sensor chamber. Thus, the signal from second sensor 45 is a weak signal due to any interference from gas phase species and noise due to light diffusion on the sensor walls 63. By subtracting the signal of sensor 45 from first sensor 44, one creates a differential which is proportional to the concentration of black carbon. This configuration allows increase of the sensitivity for ambient measurement of black carbon, in this way also correcting the impact of environmental conditions such as humidity, temperature, etc. on the sensor signal. When more than one light source is used in each sensor 44, 45, e.g. one for black carbon and one for a different gaseous species, such as CO₂ or NO₂, the signal of second sensor 45 in this gaseous species, which is not influenced by contamination from particulate matter, can be used as a reference to correct the signal of first sensor 44, when comparing the response of the sensors for the same gas species.

The operation of said optoacoustic device is set out hereafter.

Thermal Detector

Optical detection of the temperature gradient along the third axis Z is the preferred method to measure the thermal component of the energy produced at the MT. The energy dissipated by the absorbing species at the MT, following their excitation by the modulated light incident beam 19, produces a temperature gradient along the third detection axis Z. This local temperature increase can be measured by means of reading the heat-induced index of refraction changes in response to excitations, as also captured in [8], [9].

In such an embodiment, an optical beam 19 of light of different wavelength of the modulated incident light is targeted along the third axis Z in the vicinity of the excitation volume 4 and a photosensing element is located on the opposite wall of the chamber 3 along the beam axis 19. The deflection of the beam 19 as a result of the local temperature difference and the corresponding change of the refraction index at the MT vicinity results in a decrease of the light sensed by the photosensing element. The decrease in light intensity sensed is then linked to the quantity of light absorbing species at the MT.

Sensor Sensitivity

By adjusting the pulse width, the repetition rate of the pulse train, the parameters of the frequency comb, or other parameters of the modulation function, the sensor's sensitivity can be further improved. The excitation volume 4 can also be optimized for maximum SNR, high sensitivity and low detection limit of the sensor 44. The excitation volume 4 is adjustable by modifying the cross-section of the MT flow, the flowrate of the MT flow, the cross-section of the modulated light beam and the angle of the two axes X, Y formed. The MT flow cross-section can be increased by properly sizing the inlet 6 and outlet 8 of the sensor 44 for the MT flow. Increasing the two openings, inlet and outlet, may also be used to increase the flowrate which results in more absorbing species per unit of time brought in the excitation volume 4.

Ideally, the cross-section of the MT flow and the light beam 19 should have the same diameters where they cross each other. For a higher cross-section of the MT flow, a wider beam for the incident light is required. With the appropriate choice of collimation and focusing optics, the shape of the laser beam 19 on the excitation volume 4 can vary from a small, tightly focused, point to a large collimated beam. The spatial shape and time modulation waveforms can be chosen so that the sensor's sensitivity is maximum and the detection limit low.

The chamber wall 63 material is selected for optimal sound reflection and minimum transmission and absorption of incident waves to improve the sensitivity. Thin, high-density solid walls 63 offer such characteristics. High-density plastic offers a good compromise between low material cost and high sound reflection. Metals, such as steel, and aluminum and bronze X offer advanced sound reflection but may entail higher manufacturing costs. Metal plating of the plastic wall entails decreased costs and enhanced sound reflection properties. Care is taken to avoid material corrosion in specific sensor applications that are exposed to corrosive fluids.

Minimum light absorption of the wall 63 material is also required to avoid thermal and acoustic energy generation by any diffuse light in the chamber 3. Such energy generation would result in increasing the background of the measurement thus reducing sensitivity. Techniques to increase the light reflectance by means of surface polishing, metal plating, or painting with light color of the surface walls are expected to improve the signal to noise ratio.

By attaching the amplifier circuit on the sensor 44, optimal amplification and transmission of the signal to the acquisition unit is achieved for minimum losses and maximum SNR. Increased sensitivity is achieved by optimizing the chamber's 3 geometry, and with its said ellipsoid shape by fine-tuning the eccentricity or the scaling factor in order to increase sensitivity without any compromise on contamination, notably by selecting an a/b ratio possibly in the range 1.5 to 4.

Sensitivity is also increased by improving the signal to noise ratio SNR. For promoting this, two sensors 44, 45 are arranged in parallel, with the first sensor 44 in normal operation and the second one 45 with its MT fluid flow blocked to the species for which the first sensor 44 produces a signal. The second sensor 45 can be equipped with a device to remove black carbon before this reaches the excitation volume 4. The signal of the second sensor 45 can be used to improve the measured signal from the first sensor 44, using known signal correction techniques, including interference bias notably from environmental pollutants or cross-interference, offset and linearity corrections.

An optical monitoring of measurement target is performed as follows. When particles or gases are illuminated, light will be both absorbed and scattered. Optoacoustic is responsive only to light absorption which makes them ideal for BC identification. Light detection in 180° is sensitive to both absorption and scattering while detection in other angles, e.g. 45° or 90°, is only sensitive to scattering. The sensor 44 may combine both optoacoustic detection and detection of scattered light in various angles between ˜0° and 180° stereoscopic. In particular for particles, this will allow obtaining information for particle size and potentially non-carbonaceous composition in addition to BC mass. For this purpose, the sensor 44 may utilize fibers to guide the light scattered in different angles in sensitive photodetectors. The scattering angle distribution of the light depends on the size distribution of the particles that the light illuminates. According to the scattering theories of Mie, Rayleigh or Rayleigh-Debye-Gans, a particle size distribution can be derived.

Regarding decrease of contamination, retaining clean optics and a clean sound detector is essential to retain long-term sensor durability. Accumulation of particles on the optical path decreases light sensitivity, while accumulation on the sound detector changes its natural frequency. Long term operation is naturally achieved by locating the sensitive components away from the flow path. The acoustic detector 5 is by design located away from the incoming pollutant flow. The optical path ˜Y is also by design perpendicular to the pollutant flow ˜X to avoid the optics coming close to pollutant contaminants. To further avoid contaminants deposition also by buoyancy and natural convection, a mild positive thermal gradient can be retained between the pollutant path and the sensitive elements to enable further protection by thermo-repulsion. An acoustically transparent but particle non-permeable material can be used to separate the acoustic detector from the MT flow to protect it from contamination.

Measurement of the target flowrate is carried out with the chamber 3 introducing minimum resistance to the MT flow thanks to its simplified design as shown in FIG. 2. Therefore, the MT flow can be generated with multiple means. A small flow generator such as a pump, can be connected to the outlet duct of the chamber 3 and create a flow by underpressure: This guarantees a steady flowrate in the order of some liters per minute and can be used for both ambient and emission source measurements.

For environmental applications, a pump can be avoided by proper shaping of the inlet and outlet ducts of the sensor. Several methods can be used to establish a small flowrate through the sensor. Directing a weak flow stream created by a fan at a properly angled outlet duct creates an MT flow due to the Bernoulli effect. The fan creates an air stream at a direction with an angle to the outlet duct axis. If the angle is above 90 degrees, the accelerating flow around the duct exit creates underpressure and generates an MT flow in the chamber 3. A second method involves the formation of a small temperature gradient in the chamber along the MT flow axis X. This can be created by a small heat source, such as an electrical resistance positioned at the outlet duct walls, which generates an MT flow by natural convection.

In conditions where the species of interest are in forced motion before entering the sensor 44, such as in exhaust lines of vehicles or vessels, or flue gases in stacks, the line transporting the species can serve as the sensor chamber 3. In this case, the MT flow is the actual flow of the transported fluid in said exhaust line or stack. In another configuration, the forced motion of the measurement species can be employed to create a flowrate through the sensor 44, due to Bernoulli principle. In such an embodiment, a Bernoulli-based sensor tip is placed in said exhaust line/stack creating a pressure difference between the inlet 6 and outlet 8 of the sensor 44 and consequently a flowrate through the measurement chamber 3.

By multi-wavelength illumination and spectral separation, the different absorbers and pollutant species can later be separated using spectral un-mixing methods. The Optoacoustic signal S_{λ} is proportional to the excitation energy of the laser source, the absorption value of the species in MT and the concentration of these species:

$${S}_{λ} = {I}_{λ} {\sum }_{i}^{n} {μ}_{λ}^{i} {C}_{i}$$

where S_{λ} is the optoacoustic signal of the laser source with wavelength λ, I_{λ} is the optical energy of the laser source with wavelength λ, μ_{λ}ⁱ the absorption of the gas or particulate i at wavelength λ and Cᵢ the concentration of the i-th gas or particulate in the MT. Therefore, a system of n equations of n unknowns is formed that can be easily solved analytically to determine the concentration of the n pollutant gases or particulates in the MT, as long as there are n wavelengths.

Laser diodes and LEDs are available in many wavelengths, covering the range from the UV, the visible and the NIR (˜300 nm up to ˜1500 nm). The different wavelengths will excite different gases such as NO₂ (350 nm-600 nm), black and brown carbon particles, mainly in the visible and NIR spectrum, CO₂ (˜1400 nm), SO₂ (˜300-320 nm). The different absorbers, pollutant gases and particulates, can later be separated using the abovementioned spectral unmixing methods. Using this method, the sensor 44 is able to detect and monitor in real time multiple gases and light-absorbing particulate species simultaneously.

When only a limited number of wavelengths is available, filters can alternatively be used to remove certain gases or particulates from the MT and extract information about the different pollutants by simple subtraction methods. Such an implementation is presented in FIG. 5.

Proper electronics circuitry is integrated on the sensor 44 to drive the laser diodes 21, 22, to amplify the detected optoacoustic signal, to digitize and acquire the optical as well as the optoacoustic signals, process them and transmit them to a collection and data storage point. In order to achieve this, microprocessors, e.g. Arduino, field programmable gate arrays (FPGA), analog to digital converters (ADC), operational and trans-impedance amplifiers, Bluetooth or other transmitting technologies can be used.

A wide variety of applications of the present sensing system notably includes the sensor detecting and monitoring gaseous or particulate pollutants from combustion, including engines, boilers, burners and other combustion setups. In such applications, it can provide real-time evaluation of pollutants' concentration at the exhaust of cars, vessels, airplanes and stationary engines and combustion devices. One particular application of such a sensor in engine exhaust would be to server as on-board detection sensor or on-board measurement sensor referred to hereafter as OBD and OBM respectively. In particular for such applications, knowledge of the concentration and size distribution of particles in the MT mean the sensor can be configured as a particle number sensor referred to hereafter as PN.

In addition, use of light at different wavelengths entails the sensor's use as a multicomponent sensor. In particular, the possibility to measure CO₂ is important because this can be used to monitor the actual emissions of CO₂, a measure which is not possible today.

In applications in ships, the measurement of SO₂ is important because of the regulation of sulfur in fuels. This is achieved again by using the suitable wavelength for the light source.

The low energy consumption, packed size, low cost and increased sensitivity means the sensor can also be used for ambient studies. Primarily, it can be used for pollutants concentration monitoring of singular locations. In such a case, the sensor is positioned in the location where measurements on the concentration of pollutants are required. Such a location can be either in the open environment (atmosphere) or in specific location close to an emissions source (field) or an enclosed location for the monitoring of occupational or general indoor air quality.

A distributed network of such sensors for environmental sampling provides information about the air quality of the environment. The sensor can be combined with the signal transmission functionality that will allow storage of information to the cloud. That network also provides an excellent input for aerosol modeling by climate models, which traditionally have to assume particle mass concentration or particle absorption cross section.

Artificial Intelligence, Meta-data is further involved in that a great quantity of data will be made available by utilizing a network array on a regional or even global level. These data can then be collected and stored. By means of artificial intelligence algorithms, data can be processed in a very efficient way and complex patterns can be identified. For example, the source of pollution for remote areas can be identified and countermeasures can be designed with increased accuracy. Patterns regarding pollutants' aging can also be evaluated.

### REFERENCES

[1] IPCC, “Summary for Policymakers—Global warming of 1.5° C., an IPCC special report.”
[2] E. Vignati, M. Karl, M. Krol, J. Wilson, P. Stier, and F. Cavalli, “Sources of uncertainties in modelling black carbon at the global scale,” Atmos. Chem. Phys., vol. 10, no. 6, pp. 2595-2611, 2010.
[3] O. A. M. Popoola et al., “Use of networks of low cost air quality sensors to quantify air quality in urban settings,” Atmos. Environ., vol. 194, no. September, pp. 58-70, 2018.
[4] B. Giechaskiel et al., “Review of motor vehicle particulate emissions sampling and measurement: From smoke and filter mass to particle number;” J. Aerosol Sci., vol. 67, pp. 48-86, 2014.
[5] T. C. Bond, T. L. Anderson, and D. Campbell, “Calibration and Intercomparison of Filter-Based Measurements of Visible Light Absorption by Aerosols,” Aerosol Sci. Technol., vol. 30, no. 6, pp. 582-600, 1999.
[6] Magee Scientific, “Advanced Measurement of Black Carbon,” p. 2, 2015.
[7] A. Stylogiannis, L. Prade, A. Buehler, J. Aguirre, G. Sergiadis, and V. Ntziachristos, “Continuous wave laser diodes enable fast optoacoustic imaging,” Photoacoustics, vol. 9, pp. 31-38, 2018.
[8]G. Wissmeyer, M. A. Pleitez, A. Rosenthal, and V. Ntziachristos, “Looking at sound: optoacoustics with all-optical ultrasound detection,” Light Sci. Appl., vol. 7, No 1 2018
[9] J. C. Murphy and L. C. Aamodt, “Photothermal spectroscopy using optical beam probing: Mirage effect,” J. Appl. Phys., vol. 51, no. 9, pp. 4580-4588, 1980.

1.-35. (canceled)

36. An apparatus for measuring a measurement target in a fluid flow (contaminant in an aqueous flow), the apparatus comprising:
an ellipsoidal measurement chamber (3) having a first focal point (37) and a second focal point (38);
a duct (6, 7, 8) configured to guide a fluid flow through the measurement chamber (3) along a first axis (X) through the first focal point (37);
light source means (21, 22) for generating an excitation light beam (19) of modulated intensity;
means (12, 15, 16) configured to pass the excitation light beam (19) through the measurement chamber (3) along a second axis (Y), which is different from the first axis (X), such that the excitation light beam crosses the fluid flow at the first focal point (37) and that the crossing of the fluid flow and the excitation light beam defines an excitation volume (4) within the fluid flow is excited by the excitation light beam to generate acoustic waves; and
detecting means (5) arranged at the second focal point (38) and configured to detect said acoustic waves, wherein the detecting means has no direct contact with the fluid flow, and wherein the ellipsoidal measurement chamber has inner walls that are configured to focus the acoustic waves generated by the excitation light beam (19) within the excitation volume (4) onto the detecting means (5).

37. Apparatus for measuring a measurement target in a fluid flow (contaminant in an aqueous flow) according to claim 36, comprising light source means (21, 22), measuring means (44) with a chamber (3) and detecting means (5),
wherein said measuring means constituting a measuring cell consist of an optical absorption sensor (44), the chamber (3) whereof comprises ducting means (70) to duct the flow of a fluid containing a measurement target (MT) and concentrates the energy produced in response to the excitation for detection, wherein said excitation is produced within an excitation volume (4), which is formed at the crossing of a beam (19) generated by said light source means (21),
wherein the acoustic chamber (3) has a curved shape that is such that the excitation volume (4) is formed at a first focal point (F₁) thereof and the detection area (5) at its second focal point (F₂) located at a distance (d) from said first point (F₁),
characterized in that said light source means (21, 22) is configured to generate an excitation beam (19) of modulated intensity and in that the said detector means (5) is configured to detect an acoustic signal, whereby a signal is produced within the chamber (3) by excitation light, with the flow of said measurement target (MT) in their intersection with said beam (19),
wherein the flow path has a first axis (X), which is defined by a sample inlet (6) and a sample outlet (8) for the sample flow, and the light beam (19) has a second axis (Y), which is defined by a light inlet (6) and inlet and exit windows (12) for the light passage, by which the species flow and the incident light beam (19) follow a mutually different optical path according to said X-, resp. Y-direction, within said chamber (3), further wherein the excitation produces energy comprising a thermal and an acoustic component, either of which is sensed by said detecting means (5),
wherein said acoustic chamber (3) focuses said sample flow to a remote detection means (5) over said distance (d) from said first point (F₁) of said excitation volume (4) thereby avoiding a direct contact between said measurement target (MT) and the detector (5), by virtue whereof the sensitivity in detecting the energy produced on a measurement target (MT) in response to its excitation, is increased using light of modulated intensity.

38. Apparatus for measuring a measurement target (MT) according to claim 37,
wherein said chamber (3) has an ellipsoidal shape with a first focal point (F₁) and a second focal point (F₂), wherein said guiding means (70) guide a gas flow across the first focal point (F₁) along said X axis;
said light beam (19) and said flow define an intersection volume that allows excitation of said measurement target (MT), wherein said intersection volume forms said excitation volume (4) of said measurement target (MT) flow by the light beam (19) at their intersection and
wherein the ellipsoid acoustic chamber (3) has said excitation volume (4) located at its first ellipsis focal point corresponding to said first point (F₁) and the detection area (5) located at its second ellipsis focal point corresponding to said second point (F₂),
in that said ellipsoid chamber (3) concentrates acoustic energy, which is generated at the said excitation volume (4) in response to the light of modulated intensity, and focuses said acoustic energy to a remote sound detection area (5) corresponding to said second point (F₂) located at a distance (d) from said first point (F₁) of said excitation volume (4) along a third axis (Z), wherein said two axes (X, Y) are mutually positioned with a certain angle to each other thus forming a plane (α), which said third axis (Z) does not belong to,
wherein said second point (F₂) defines a sound detection area, wherein said detector (5) is located to detect the energy generated in response to the light of modulated intensity, wherein said acoustic detector (5) is located away from the incoming measurement target (MT) pollutant flow, thus being remote at said distance (d) therefrom,
particularly wherein said axes (X, Y, Z) are perpendicular to each other having a mutual angle of 90°, wherein the species flow (MT) and the incident light beam (19) follow a mutually different optical path within said chamber (3) according to said X-, resp. Y-direction, that is mutually orthogonal, wherein the optical path of the said light beam (19) according to said Y-direction is perpendicular to said measurement target (MT) pollutant flow according to said X-, direction thereby avoiding the optics coming close to pollutant contaminants in that said acoustic detector (5) is thus kept remote from the species flow (MT) containing said pollutant contaminants.

39. Apparatus according to claim 38, comprising
a light source (21, 22) for generating an excitation light beam (19) and a detector (5) for detecting acoustic waves;
an ellipsoidal chamber (3) having a first and a second focal point (F₁, resp. F₂);
guiding means (70) to guide a gas flow across the first focal point (F₁) along an X axis;
means for introducing the excitation light beam (19) along a Y direction passing through the first focus (F₁), thereby forming an excitation volume (4);
wherein said ellipsoidal chamber (3) comprises inner walls (63) configured to reflect acoustic waves generated in the excitation volume (4) towards the acoustic detector (5) located at the second focal point (F₂),
wherein sound is refocused by the ellipsoidal chamber (3) for an optoacoustic detection, whereas the sample configuration consists of said flow along one single axis (X) without any circulation, wherein said guiding means (70) consist of a straight section located at the reduced focal end section (37) of said ellipsoidal chamber (3) thereby passing the flow remaining a minimum of time in said ellipsoidal chamber (3), further wherein optoacoustic detection is applied without trapping medium, wherein the deposition of contaminants is minimized, wherein the concentration of contaminants in said MT is measured and determined, whereas the sample flows inside the chamber (3) and the optics, the acoustic detector (5) and the chamber (3) are then protected from contamination through an optical path (Y) perpendicular to incoming pollutant flow (X); wherein the said detector (5) is located away from the flow path being remote over said distance (d).

40. Apparatus according to claim 37, comprising multiple optical detectors that are positioned at different angles over said plane (α) to evaluate light scattering, in particular wherein in addition to said light of modulated intensity (21), said sensor (44) comprises additional light sources (22) and corresponding sensing means associated thereto, thereby providing complementary reading means for said measurement target (MT) via optical detection,
more particularly wherein that said additional light sources (22) are at multiple wavelengths (λᵢ), wherein the light beam (19) is formed by said plurality of modulated light sources (21, 22) at different wavelengths (λᵢ), in particular laser diodes (LD) or Light Emitting Diodes (LED), respectively as low cost and compact light sources, wherein said laser diodes and LEDs are driven with very high repetition rates (duty cycles), allowing for an improved signal to noise ratio (SNR) through averaging without increasing the acquisition time, more particularly low-cost modulated by means of pulses, notably nanosecond modulation, esp. sinusoidal.

41. Apparatus according to claim 37, wherein the axis ratio a/b of said ellipsoid chamber (3) is comprised in a range between 1.5 and 4, where (a) is its major axis and (b) is the small one, particularly wherein the eccentricity of said ellipsoidal chamber (3) or the scaling factor is fine-tuned, by virtue whereof sensitivity is additionally increased; and/or
wherein said chamber (3) is provided with high density solid walls (63) with high reflection power, in particular thin high density plastic walls (63) and/or metallic, preferably with metal plating of said plastic;
and/or wherein said acoustic detector (5) is separated from said measurement target (MT) flow by means of a separating means made of an acoustically transparent but particle non-permeable material, thereby protecting it from contamination;
and/or wherein said chamber (3) comprises two casing halves (1, 2), each having a recess in the shape of half said ellipsoid being aligned mutually according to said third axis (Z) one of which (1) shelters said acoustic detector (5), whereas the other half (2) shelters said light source (21, 22), the transmission of the light beam (19) and the flow of the measurement target (MT).

42. Apparatus according to claim 41, wherein fiber power combiners (27) are incorporated into said apparatus by means whereof the output signals of the plurality of said light sources (21, 22) is combined into one single fiber (72).

43. Apparatus according to claim 37, wherein said detector (5) is a quartz tuning fork (QTF) that is responsive only on narrow bands of acoustic frequencies, main frequency and its harmonics, thus delivering a high Q-factor, wherein said QTF delivers a high signal to noise ratio (SNR), thus increasing the sensitivity of said sensor (44), even with low power light sources (21, 22).

44. System comprising an array of sensing apparatus as defined in claim 37, wherein said array comprises at least two sensors (44, 45) which are arranged mutually in parallel, wherein a first sensor (44) is connected in normal operation, whereas the second sensor (45) is incorporated with its said measurement target (MT) flow blocked by an absorbing species (87) at said measurement target (MT) for which said first sensor (44) produces a signal, particularly
wherein said second sensor (45) is equipped with a device, notably a filter, removing black carbon (BC) before it reaches said excitation volume (4),
more particularly wherein said array of sensors is arranged as a control circuit of sensors wherein a feedback is incorporated for control of the signal of said second sensor (45) that is used to improve the measured signal from said first sensor (44), notably by means of a signal correction means, particularly wherein both said sensors (44, 45) are identical; especially wherein said sensor (44, 45) is portable.

45. Method for operating a high sensitivity optical absorption sensing apparatus as defined in claim 36, wherein said measurement target (MT) flow is introduced in said chamber (3) by entering said measurement target (MT) through the chamber's inlet (6), which is further passed through said ducting means (70) which are straight in parallel with said small axis (b) providing a shortened path to said measurement target flow (MT) thereby involving a way of reduced resistance to said measurement target flow (MT) and which measurement target flow (MT) is further exited at the chamber's outlet (8), wherein the inlet pipe (6) contains a reduced section (7) involving an acceleration for said measurement target (MT) flow and a smooth rim (76) upstream the chamber (3), having an end section (77) with a diameter corresponding to the diameter of said light beam (19) just before it enters therein, under the action whereof (76) said measurement target (MT) flow is accelerated and then focused in said first ellipsis focal point (F₁).

46. Method according to claim 45, wherein said chamber (3) shelters said measurement target (MT) flow, wherein said measurement target (MT) is excited by the modulated incident light, and wherein the energy derived from the excitation of said measurement target (MT) is concentrated by its ellipsoidal configuration, thereby yielding an effective measurement with high sensitivity, wherein the energy produced by said incident light excitation on said measurement target (MT) has a thermal component with slight increase of local temperature, and an acoustic component with the generation of an ultrasound wave being detected along said third axis (Z) in said chamber (3), wherein both thermal and acoustic energies relate to the amount of light energy incident to said excitation volume (4) and the quantity of absorbing species (87) present in said measurement target; particularly wherein sound is refocused at low frequencies in the range 10-200 kHz yielding a large acoustic focal area of the order of the mm, by virtue whereof sensitivity is made independent from the exact positioning of the acoustic detector or external vibrations.

47. Method according to claim 45, for operating an apparatus as defined in claim 5, for environmental application, wherein the said thermal component of the energy produced at said measurement target flow (MT) is measured by optical detection of the temperature gradient (∇T) along the third axis (Z), wherein the energy dissipated by the absorbing species (87) in the said measurement target flow (MT), following their excitation by a modulated light incident beam (18), produces a temperature gradient (∇T) along said third detection axis (Z), wherein this local temperature increase (∇T) is measured by reading the heat-induced index of refraction changes in response to excitations,
wherein a beam of light of wavelengths (λ₂) different from the one (λ₁) of said modulated incident light (19) is targeted along said third axis (Z) in the vicinity of the excitation volume (4), wherein a deflection of the beam is caused resulting from the local temperature difference (∇T) and the corresponding change of the refraction index at the said measurement target flow (MT) vicinity that generates a decrease of the light which is sensed by the photosensing detector (5) located on an opposite wall (63) of the chamber (3) along the beam axis (Y), wherein said decrease in light intensity is then linked to the quantity of said light absorbing species (87) in the said measurement target flow (MT).

48. Method according to claim 46, wherein the excitation volume (4) for a maximum signal to noise ratio (SNR), the high sensitivity and low detection limit of the sensor (44) are optimized, wherein the excitation volume (4) is adjusted by modifying the cross-section of said measurement target (MT) flow, the flowrate thereof, the cross-section of the modulated light beam (19) and the angle (α) formed between said two axes (X, Y), wherein said measurement target (MT) flow cross-section is increased by sizing the inlet (6) and outlet (8) of the sensor (44) for said MT-flow, further wherein said two openings—inlet (6) and outlet (8)—are enlarged, which increases the flowrate (MT) by virtue whereof more absorbing species (87) per unit of time is brought in said excitation volume (4), by virtue whereof the sensor's sensitivity is increased; particularly
wherein the cross-section of said sample flow (MT) and the light beam (19) are monitored for having the same diameters where they cross each other at their intersection.

49. Method according to claim 45, wherein said measurement target (MT) is submitted to optical monitoring, wherein particles or gases are illuminated, after which light gets both absorbed and scattered, and black carbon (BC) is identified in that optoacoustics is responsive only to light absorption and said BC is identified, whereas light detection in 180° is sensitive to both absorption and scattering while detection in other angles, such as 45° or 90°, is only sensitive to scattering, wherein the sensor (44) with its ellipsoidal geometry combines both optoacoustic detection and detection of scattered light in various angles between 0° and 180° stereoscopic;
in particular wherein for particles, information for particle size and potentially non-carbonaceous composition in addition to said BC mass is obtained therewith; more particularly
wherein fibers guide the light scattered in different angles in sensitive photodetectors, whereas the scattering angle distribution of the light depends on the size distribution of the particles that the light illuminates, by virtue whereof a particle size distribution is derived accordingly, thereby producing the required identification data, wherein the characteristics of the pollutants being measured are deduced from the scattering versus absorption measurements thus enabling to distinguish between light absorption and scattering.

50. Method according to claim 46, wherein a moderate positive thermal gradient (∇T) is maintained between the pollutant path and the sensitive elements, esp. sensing elements, thereby further protecting by thermo-repulsion, thereby further avoiding contaminants deposition by buoyancy and natural convection; in particular
wherein said plurality of laser diodes (21, 22) excites various substances, notably gases and particles, and wherein the total signal is spectrally unmixed to measure different pollutants.

51. Method for the detection of acoustic signals, scattered light and absorption signals at different angles according to claim 45, wherein a plurality of sample's characteristics is evaluated by means of the sensor's multiple signals, wherein the optoacoustic signal provides the mass concentration of certain gas and particulate species (87) to be identified, wherein light scattering is additionally monitored in different angles and wherein the size distribution of the particles is then calculated; further wherein the gas sample component notably including NO₂, BC resp. other carbonaceous particles, CO₂, SO₂, dust, ashes is distinguished, by means whereof light absorption and scattering are mutually distinguished from one another.

52. Method according to claim 45, wherein different absorbers and pollutant species (87) are separated by spectral unmixing, wherein the optoacoustic signal (S_{λ}) is proportional to the excitation energy of the laser source (21) the absorption value of the species (87) in said measurement target (MT) and the concentration of these species (87) as
$${S}_{λ} = {I}_{λ} {\sum }_{i}^{n} {μ}_{λ}^{i} {C}_{i}$$
where (S_{λ}) is the optoacoustic signal of the laser source with wavelength λ, I_{λ} is the optical energy of the laser source with wavelength λ, μ_{λ}ⁱ the absorption of the gas or particulate i at wavelength λ and Cᵢ the concentration of the i^{th} gas or particulate in said measurement target (MT), wherein a system of n equations of n unknowns is formed that is solved analytically thereby yielding the concentration of the n pollutant gases or particulates in said measurement target (MT), which are thus determined with n wavelengths.

53. Method according to claim 45, wherein electronics circuitry (20) is integrated on the sensor (44) by means whereof the laser diodes (21, 22) are driven, wherein the detected optoacoustic signal is amplified, the optical as well as the optoacoustic signals are digitized and acquired, processed and transmitted to a collection and data storage point.

54. Method according to claim 45, for operating a photoacoustic device as defined in claim 2, wherein sound is refocused by the ellipsoidal chamber (3) yielding an optoacoustic detection, whereas the sample configuration consists of said flow (MT) along one single axis (X) without any circulation, and wherein the flow (MT) remains a minimum time in the ellipsoidal chamber (3), further wherein an optoacoustic detection is applied without trapping medium, still further wherein the deposition of the contaminants to be measured is minimized, yet further wherein the concentration of contaminants in a flow is measured and determined, whereas the sample (87) flows inside the chamber (3) and the optics, the acoustic detector (5) and the chamber (3) are then protected from contamination through an optical path (Y) perpendicular to incoming pollutant flow (MT), wherein the detector (5) is located away from the flow path (Y); and wherein through thermo-repulsion, a mild positive thermal gradient is maintained between the pollutant path (X) and the sensitive elements (5).

55. A method of measuring gaseous and particulate species (87) using a photoacoustic apparatus as defined in claim 1 to measure in the exhaust of different combustion systems including cars, vessels, aircraft, stationary engines, comprising the steps of
detecting and monitoring gaseous or particulate pollutants from combustion, including engines, boilers, burners and other combustion setups, are detected and monitored,
wherein said sensor (44, 45) provides real-time evaluation of pollutants' concentration at said exhaust of said combustion systems, stationary engines and combustion devices,
wherein said sensor in engine exhaust serves as on-board detection (OBD) sensor or on-board monitoring (OBM) sensor,
wherein said sensor is configured as a particle number (PN) sensor; or
wherein air quality is detected and measured for atmospheric pollution concentrations and/or wherein light at different wavelengths is used and/or wherein the optoacoustic sensor is used as a multicomponent sensor, wherein the CO₂ is measured to monitor the actual emissions of CO₂.
